(19) United States
(12) Patent Application Publication
(10) Pub. No.: US 2021/0291352 A1
(43) Pub. Date: Sep. 23, 2021

(54) AIR CONDITONING COMPRESSOR HANDLING TOOL

(71) Applicant: Jacob Celis, Mesa, AZ (US)

(72) Inventor: Jacob Celis, Mesa, AZ (US)

(21) Appl. No.: 17/199,880

(22) Filed: Mar. 12, 2021

Related U.S. Application Data
(60) Provisional application No. 62/991,323, filed on Mar. 18, 2020.

(51) Int. Cl. B25J 1/04

(52) U.S. Cl. CPC B25J 1/04

(57) ABSTRACT

An air conditioning compressor handling tool including an elongated tubular body with a coupling lug extending from the sidewall proximate the upper end and a cradle coupled to the sidewall in axial alignment with the coupling lug proximate the lower end. An elongated extension member telescopingly positionable within the elongated tubular body. A plurality of apertures formed along the length of the extension member. First and second adjustable handles each with a collar positionable coaxially over the extension member, a grip extending from the collar member, and apertures formed through the collar members. A plurality of pins adaptable to extend through aligned apertures in coaxially aligned components to hold the coaxially aligned components in a desired relative position.

### CROSS-REFERENCE TO RELATED APPLICATION

This application claims the benefit of U.S. Provisional Patent Application No. 62/991,323, filed 18 Mar. 2020.

### FIELD OF THE INVENTION

This invention relates to air conditioner tools.

More particularly, the present invention relates to tools for handling air conditioning compressors.

### BACKGROUND OF THE INVENTION

Air conditioning compressors are awkwardly shaped and very hard to handle or move for any distance. For example, moving a defective air conditioning compressor from the air conditioning unit to a remotely located truck and moving a new air conditioning compressor from the truck to the air conditioning unit can be very tiring and even dangerous. At present, to the best of the inventor's knowledge, air conditioning compressors (damaged or new) are simply picked up manually and carried by brute force to a desired destination. While self-powered vehicles (e.g. electric or gas vehicles could be used, the cost and storage problems are insurmountable. The present invention is a tool designed to make such a transfer as easy as possible with a minimum of additional equipment and cost.

It would be highly advantageous, therefore, to remedy this and other deficiencies inherent in the prior art.

Accordingly, it is an object of the present invention to provide a new and improved air conditioning compressor handling tool.

It is another object of the present invention to provide a new and improved air conditioning compressor handling tool that is low cost and easy to use and store.

### SUMMARY OF THE INVENTION

Briefly to achieve the desired objects and advantages of the present invention an air conditioning compressor handling tool is disclosed that includes a body removably attachable to an air conditioning compressor and a pair of handles attachable to the body for lifting and carrying the air conditioning compressor.

To further achieve the desired objects and advantages of the present invention a specific embodiment of an air conditioning compressor handling tool is disclosed that includes an elongated tubular body having an upper end and a lower end, the elongated tubular body being defined by a sidewall defining a central, axially extending opening at the upper end, a coupling lug extending from the sidewall proximate the upper end, a cradle coupled to the sidewall in axial alignment with the coupling lug proximate the lower end, and a pair of aligned apertures formed through opposing sides of the sidewall proximate the upper end. An elongated extension member has an outer dimension smaller than an inner dimension of the elongated tubular body and is telescopingly positionable within the central, axially extending opening in the elongated tubular body. A plurality of spaced apart aligned aperture pairs are formed transversely through and longitudinally along the length of the elongated extension member. A first adjustable handle includes a collar member having an inner dimension slightly larger than the outer dimension of the extension member and a longitudinal axis so that the first adjustable handle is positionable coaxially over the elongated extension member, a grip extending from the collar member substantially perpendicularly to the longitudinal axis of the collar member, and a pair of aligned apertures formed through opposing sides of the collar member. A second adjustable handle includes a collar member having an inner dimension slightly larger than the outer dimension of the extension member and a longitudinal axis so that the second adjustable handle is positionable coaxially over the elongated extension member, a grip extending from the collar member substantially perpendicularly to the longitudinal axis of the collar member, and a pair of aligned apertures formed through opposing sides of the collar member. A plurality of pins adaptable to extend through aligned apertures in coaxially aligned components to hold the coaxially aligned components in a desired relative position.

The desired objects and advantages of the instant invention are further achieved in a preferred example of an air conditioning compressor handling tool including an elongated tubular body having an upper end and a lower end, the elongated tubular body being defined by a sidewall defining a central, axially extending opening at the upper end, a coupling lug extending from the sidewall proximate the upper end, a cradle coupled to the sidewall in axial alignment with the coupling lug proximate the lower end, and a pair of aligned apertures formed through opposing sides of the sidewall proximate the upper end. An elongated extension member having an outer dimension smaller than an inner dimension of the elongated tubular body and telescopingly positioned coaxially within the central, axially extending opening in the elongated tubular body, a plurality of spaced apart aligned aperture pairs formed transversely through and longitudinally along the length of the elongated extension member, one of the plurality of spaced apart aligned aperture pairs transversely aligned with the pair of aligned apertures formed through opposing sides of the sidewall of elongated tubular body. A first pin extending through the one of the plurality of spaced apart aligned aperture pairs and the pair of aligned apertures formed through opposing sides of the sidewall of the elongated tubular body. A first adjustable handle including a collar member having in inner dimension slightly larger than the outer dimension of the extension member and a longitudinal axis with the first adjustable handle positioned coaxially over the elongated extension member, a grip extending from the collar member substantially perpendicularly to the longitudinal axis of the collar member, and a pair of aligned apertures formed through opposing sides of the collar member. A second pin extending through the pair of aligned apertures formed through opposing sides of the collar member of the first adjustable handle and a pair of the plurality of spaced apart aligned aperture pairs formed transversely through the elongated extension member. A second adjustable handle including a collar member having in inner dimension slightly larger than the outer dimension of the extension member and a longitudinal axis with the second adjustable handle positioned coaxially over the elongated extension member, a grip extending from the collar member substantially perpendicularly to the longitudinal axis of the collar member, and a pair of aligned apertures formed through opposing sides of the collar member. A third pin extending through the pair of aligned apertures formed through opposing sides of the collar member of the second adjustable handle and a pair of the plurality of spaced apart aligned aperture pairs formed transversely through the elongated extension member.

### BRIEF DESCRIPTION OF THE DRAWINGS

Specific objects and advantages of the invention will become readily apparent to those skilled in the art from the following detailed description of a preferred embodiment thereof, taken in conjunction with the drawings in which:

FIG. 1 is a perspective view of an air conditioning compressor handling tool according to the present invention;

FIG. 2 is an exploded view of the compressor handling tool of FIG. 1;

FIG. 3 is a perspective view of a compressor handling tool according to the present invention with an engaged compressor; and

FIG. 4 is a perspective view of a conventional compressor.

### DETAILED DESCRIPTION OF THE DRAWINGS

The inventive air conditioning compressor handling tool includes a body removably attachable to an air conditioning compressor and a pair of handles attachable to the body so that the air conditioning compressor can be easily and conveniently lifted and carried. In a preferred embodiment an extension member is attachable to the body to provide adjustment for different operators and the pair of handles are attachable to the extension member. A more specific preferred embodiment is described in detail below.

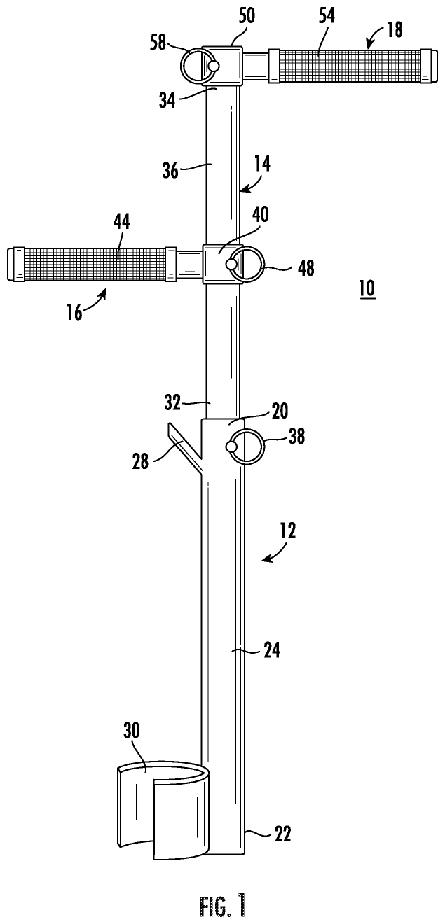

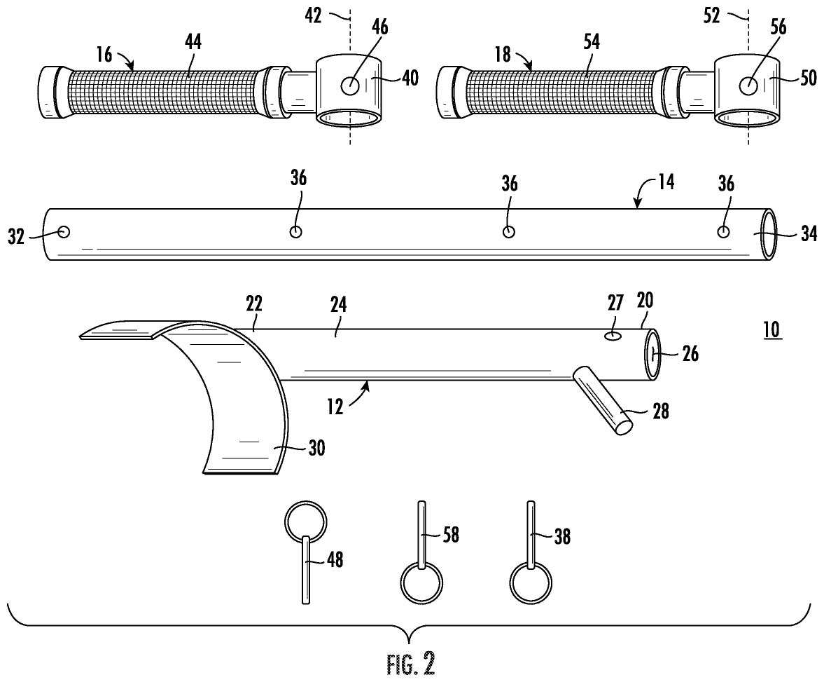

Turning now to the drawings in which like reference characters indicate corresponding elements throughout the several views, attention is directed to FIGS. 1 and 2 which illustrate an air conditioning compressor handling tool generally designated 10. Compressor handling tool 10 includes an elongated tubular body 12, an extension member 14 telescopingly received by body 12, a first adjustable handle 16 and a second adjustable handle 18. Body 12 is preferably an elongated tubular member having an inner diameter or dimension (if body 12 does not have a circular cross-section), a top end 20, a bottom end 22, and a sidewall 24 defining an interior volume 26. While elongated tubular body 12 and extension member 14 are illustrated as circular, it should be understood that any cross-section (e.g. square, oval, etc.) that can perform the describe functions can be used. Also, interior volume 26 of tubular body 12 may extend the full length or only partially. Further, extension member 14 may be tubular to reduce the weight or can be a solid rod for additional strength. A pair of aligned apertures 27 are formed through opposing sides of sidewall 24 in communication with interior volume 26 proximate top end 20. A coupling lug 28 extends from sidewall 24 of body 12 proximate top end 20 and a cradle 30 is coupled to sidewall 24 in alignment with lug 28 and proximate bottom end 22. Coupling lug 28 extends outwardly from sidewall 24 at an upwardly directed angle, in the direction of top end 20. Cradle 30 is preferably a semicircular strip of metal fixed at a middle thereof to sidewall 24. Body 12 can be formed of substantially any metal or plastic, but to provide sufficient strength to carry a heavy compressor, steel is the preferred material.

Still referring to FIGS. 1 and 2, extension member 14 is an elongated tubular member having an outer dimension slightly smaller than the inner diameter or dimension of body 12, a lower end 32 and an upper end 34. Lower end 32 is received into interior volume 26 of body 12 through top end 20 and can be telescopingly adjusted therein. A plurality of spaced apart aligned aperture pairs 36 are formed longitudinally along the length of elongated extension member 14. Each aperture of each aperture pair 36 is formed through an opposing side of extension member 14. Extension member 14 is inserted into interior volume 26 of body 12 through top end 20 a desired distance and such that an aperture pair 36 is aligned with aperture pair 27 in body 12. Once aligned, body 12 and extension member 14 are securely held in relative position by a pin 38 inserted concurrently through aperture pair 27 and aperture pair 36. It will be understood that the term “pin” is defined herein as any device extending through aligned apertures to hold coaxially aligned components in place. Thus, the length of compressor handling tool 10 can be adjusted by removing pin 38, repositioning extension member 14 within body 12 so that aperture pair 27 is aligned with a different aperture pair 36 and replacing pin 38.

First adjustable handle 16 and a second adjustable handle 18 are both adjustably attachable to extension member 14. First adjustable handle 16 includes a collar member 40 having in inner diameter or dimension (if collar 40 and extension member 34 are not circular) slightly larger than the outer diameter or dimension of extension member 14 and a longitudinal axis 42. A grip 44 extends from collar member 40 substantially perpendicularly to longitudinal axis 42. A pair of aligned apertures 46 are formed through opposing sides of collar member 40. Collar member 40 is received over upper end 34 of extension member 14 a desired distance and such that an aperture pair 36 of extension member 14 is aligned with aperture pair 46 of collar member 40. Once aligned, first adjustable handle 16 and extension member 14 are securely held in relative position by a pin 48 inserted concurrently through aperture pair 46 and aperture pair 36.

Second adjustable handle 18 includes a collar member 50 having in inner diameter or dimension slightly larger than the outer diameter or dimension of extension member 14 and a longitudinal axis 52. A grip 54 extends from collar member 50 substantially perpendicularly to longitudinal axis 52. A pair of aligned apertures 56 are formed through opposing sides of collar member 50. Collar member 50 is received over upper end 34 of extension member 14 a desired distance and such that an aperture pair 36 of extension member 14 is aligned with aperture pair 56 of collar member 40. Once aligned, first adjustable handle 18 and extension member 14 are securely held in relative position by a pin 58 inserted concurrently through aperture pair 56 and aperture pair 36. It will be understood that first adjustable handle 16 and second adjustable handle 18 can be fitted to extension member 14 in any order, with one or the other being lower relative each other. This facilitates easer use by left and righthanded persons.

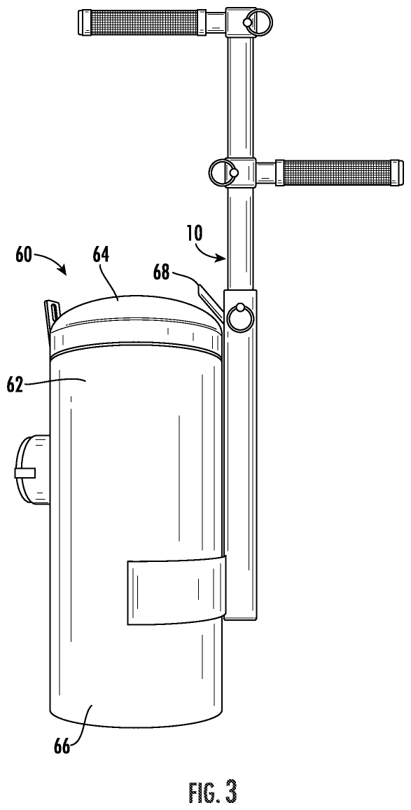

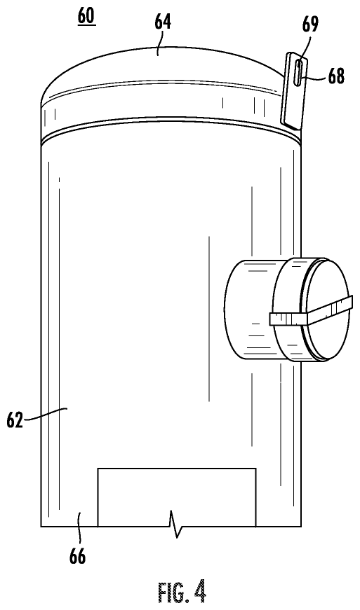

Turning now to FIG. 3, compressor handling tool 10 engaging an air conditioning compressor 60 is illustrated. With additional reference to FIG. 4, air conditioning compressor 60 is a conventional compressor for use in air conditioning systems, and includes a generally cylindrical body 62 having a top end 64 and a bottom end 66. A flange 68 having an aperture 69 extends outwardly from body 62 proximate top end 64. When engaged, cradle 30 partially encircles and abuts cylindrical body 62, and coupling lug 28 is received through aperture 69 of flange 68. Thus, a repair man can easily lift and carry air conditioning compressor 60 from the air conditioning unit (illustrated in FIG. 3) to a remotely located truck or other vehicle and return with a new air conditioning compressor.

It should be noted that air conditioning compressor tool 10 is relatively inexpensive to produce and own. Also, as can be seen in FIG. 2, in a dismantled condition air conditioning compressor tool 10 can be easily stored and quickly assembled for use. Further, air conditioning compressor tool 10 requires little or no maintenance and can be easily adjusted to fit comfortably with any size repairman.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. An air conditioning compressor handling tool comprising:
A body removably attachable to an air conditioning compressor; and
a pair of handles attachable to the body for lifting and carrying the air conditioning compressor.

2. The air conditioning compressor handling tool claimed in claim 1 further including an elongated extension member attachable to the body and designed to have the pair of handles attached thereto.

3. The air conditioning compressor handling tool claimed in claim 1 wherein the body includes an elongated tubular body having an upper end and a lower end, the elongated tubular body being defined by a sidewall defining a central, axially extending opening at the upper end, a coupling lug extending from the sidewall proximate the upper end, and a cradle coupled to the sidewall in axial alignment with the coupling lug proximate the lower end.

4. The air conditioning compressor handling tool claimed in claim 3 further including an elongated extension member having an outer dimension smaller than an inner dimension of the elongated tubular body and telescopingly positionable within the central, axially extending opening in the elongated tubular body, a plurality of spaced apart aligned aperture pairs formed transversely through and longitudinally along the length of the elongated extension member.

5. The air conditioning compressor handling tool claimed in claim 4 wherein the pair of handles include first and second adjustable handles each including a collar member having an inner dimension slightly larger than the outer dimension of the extension member and a longitudinal axis so that each of the first and second adjustable handles is positionable coaxially over the elongated extension member, and a grip extending from the collar member substantially perpendicularly to the longitudinal axis of the collar member.

6. An air conditioning compressor handling tool comprising:
an elongated tubular body having an upper end and a lower end, the elongated tubular body being defined by a sidewall defining a central, axially extending opening at the upper end, a coupling lug extending from the sidewall proximate the upper end, a cradle coupled to the sidewall in axial alignment with the coupling lug proximate the lower end, and a pair of aligned apertures formed through opposing sides of sidewall proximate the upper end;
an elongated extension member having an outer dimension smaller than an inner dimension of the elongated tubular body and telescopingly positionable coaxially within the central, axially extending opening in the elongated tubular body, a plurality of spaced apart aligned aperture pairs formed transversely through and longitudinally along the length of the elongated extension member;
a first adjustable handle including a collar member having an inner dimension slightly larger than the outer dimension of the extension member and a longitudinal axis so that the first adjustable handle is positionable coaxially over the elongated extension member, a grip extending from the collar member substantially perpendicularly to the longitudinal axis of the collar member, and a pair of aligned apertures formed through opposing sides of the collar member;
a second adjustable handle including a collar member having an inner dimension slightly larger than the outer dimension of the extension member and a longitudinal axis so that the second adjustable handle is positionable coaxially over the elongated extension member, a grip extending from the collar member substantially perpendicularly to the longitudinal axis of the collar member, and a pair of aligned apertures formed through opposing sides of the collar member; and
a plurality of pins adaptable to extend through aligned apertures in coaxially aligned components to hold the coaxially aligned components in a desired relative position.

7. The air conditioning compressor handling tool claimed in claim 6 wherein the elongated tubular body has a circular cross-section.

8. The air conditioning compressor handling tool claimed in claim 6 wherein the axially extending opening through the elongated tubular body has a circular cross-section.

9. The air conditioning compressor handling tool claimed in claim 6 wherein the axially extending opening through the elongated tubular body extends the entire length of the elongated tubular body.

10. The air conditioning compressor handling tool claimed in claim 6 wherein the elongated extension member is one of an elongated tubular ember and a solid rod.

11. The air conditioning compressor handling tool claimed in claim 6 wherein the elongated tubular body, the elongated extension member, and the first and second adjustable handles are each formed partially or completely of one of metal or plastic.

12. The air conditioning compressor handling tool claimed in claim 6 wherein the cradle coupled to the sidewall of the elongated tubular body is a semicircular strip of one of metal or plastic fixed at a middle thereof to the sidewall and designed to partially encircle and abut the body of an air conditioning compressor.

13. An air conditioning compressor handling tool comprising:
an elongated tubular body having an upper end and a lower end, the elongated tubular body being defined by a sidewall defining a central, axially extending opening at the upper end, a coupling lug extending from the sidewall proximate the upper end, a cradle coupled to the sidewall in axial alignment with the coupling lug proximate the lower end, and a pair of aligned apertures formed through opposing sides of sidewall proximate the upper end;
an elongated extension member having an outer dimension smaller than an inner dimension of the elongated tubular body and telescopingly positioned coaxially within the central, axially extending opening in the elongated tubular body, a plurality of spaced apart aligned aperture pairs formed transversely through and longitudinally along the length of the elongated extension member, one of the plurality of spaced apart aligned aperture pairs transversely aligned with the pair of aligned apertures formed through opposing sides of the sidewall of elongated tubular body;
a first pin extending through the one of the plurality of spaced apart aligned aperture pairs and the pair of aligned apertures formed through opposing sides of the sidewall of the elongated tubular body;
a first adjustable handle including a collar member having in inner dimension slightly larger than the outer dimension of the extension member and a longitudinal axis with the first adjustable handle positioned coaxially over the elongated extension member, a grip extending from the collar member substantially perpendicularly to the longitudinal axis of the collar member, and a pair of aligned apertures formed through opposing sides of the collar member;
a second pin extending through the pair of aligned apertures formed through opposing sides of the collar member of the first adjustable handle and a pair of the plurality of spaced apart aligned aperture pairs formed transversely through the elongated extension member;
a second adjustable handle including a collar member having in inner dimension slightly larger than the outer dimension of the extension member and a longitudinal axis with the second adjustable handle positioned coaxially over the elongated extension member, a grip extending from the collar member substantially perpendicularly to the longitudinal axis of the collar member, and a pair of aligned apertures formed through opposing sides of the collar member; and
a third pin extending through the pair of aligned apertures formed through opposing sides of the collar member of the second adjustable handle and a pair of the plurality of spaced apart aligned aperture pairs formed transversely through the elongated extension member.

14. The air conditioning compressor handling tool claimed in claim 13 wherein the first and second adjustable handles are attached to the elongated extension member so as to extend substantially perpendicularly outwardly in opposite directions.
